(19) United States
(12) Patent Application Publication
(10) Pub. No.: US 2005/0269123 A1
(43) Pub. Date: Dec. 8, 2005

(54) Mask for covering wall-mounted electrical devices during painting

(76) Inventor: Gregory K. Diegel, Diamond Springs, CA (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/862,919

(22) Filed: Jun. 7, 2004

(51) Int. Cl. H02G 3/14

(52) U.S. Cl. 174/66

(57) ABSTRACT

A mask for covering a wall-mounted electrical device during painting of the wall includes a plate which is sized to cover substantially all of the electrical device. A cavity in the plate receives the user-accessible element which projects from the electrical device. Tapered cylindrical studs project from the plate and fit into threaded holes in the electrical device which normally receive the screws which are used to attach a cover plate to the electrical device. The studs are configured to become wedged in the holes in the electrical device when the plate is pushed substantially flush against with the wall and hold the plate in place during painting.

### BACKGROUND AND SUMMARY OF THE INVENTION

The subject invention relates to a mask for covering wall-mounted electrical devices while the wall they are mounted in is being painted.

When interior walls are painted the cover plates for electrical devices, such as switches and plug outlets, are removed so that the wall can be painted beneath them. While it is possible to paint around a wall-mounted electrical device when the cover plate is removed, inevitably paint will be left on some of the electrical device. As a result masks have been provided to cover electrical devices when the wall they are mounted in is painted.

Heretofore these masks have been configured to snap onto the electrical device, as shown in Allen, U.S. Pat. No. 3,386,071 or Grondin, U.S. Pat. No. 5,003,128, or been attached by screws, such as shown in Maus, et al., U.S. Pat. No. 5,063,872. Neither of these is satisfactory. The former is easily dislodged during painting and the latter is time-consuming to install and remove.

The subject invention provides a mask for covering wall-mounted electrical devices having user-accessible elements which protrude from the wall during painting of the wall, the mask includes a plate which covers substantially all of the electrical device and includes a cavity that is configured to fit over the user-accessible element. One or more tapered cylindrical studs project from the plate and fit into threaded holes in the electrical device which are used to attach a cover plate to the electrical device. The studs are configured such that they become wedged in the holes when the plate is substantially flush with the wall.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIGS. 1 and 2 are perspective views of the front and back of a first embodiment of a mask embodying the subject invention.

FIGS. 3 and 4 are perspective views of the front and back of a second embodiment of a mask embodying the subject invention.

FIGS. 5 and 6 are perspective views of the front and back of a third embodiment of a mask embodying the subject invention.

FIG. 7 is a cross-sectional view, partially broken away, showing an electrical device with the mask of the subject invention being installed.

FIG. 8 is a cross-sectional view, partially broken away, showing an electrical device with the mask of the subject invention installed.

FIG. 9 is a detailed view, at an enlarged scale, showing how the mask of the subject invention is locked in place in the electrical device.

### DETAILED DESCRIPTION OF THE PREFERRED EMBODIMENT

Referring to the drawings, a mask 10 is used to temporarily cover a wall-mounted electrical device 12 when the wall 14 is being painted. The electrical device can be any standard wall-mounted device, such as a toggle switch, a standard double-plug outlet or a ground interrupted fault (GIF) outlet. The electrical device is mounted in a recess 16 in the wall, typically in an electrical box 18 which fits in the recess. The electrical device typically has flat metal tabs 20 which extend outwardly from it. The tabs overlay a flange 22 on the electrical box 18. Screws 24 fit through openings (not shown) in the tabs 20 into holes (not shown) in the flange 22. Threaded fastener plates (not shown) mounted on the flange receive the screws. Typically the tabs 20 extend out from the recess slightly and are pulled against the outside face 28 of the wall 14 when the screws 24 are tightened. This locates the electrical device such that its user-accessible element 26 projects outwardly from the wall where it can be easily accessed by the user. The user-accessible element is the toggle in a switch, the individual receptacles in a standard double-plug outlet and the plug face in a GIF outlet.

The electrical device is normally covered by a cover plate 30. The cover plate has an opening, or openings, 32 which the user-accessible element fits into when the cover plate is attached to the electrical device 12. A screw, or screws (not shown), extends through a hole, or holes, 34 in the cover plate into a threaded hole, or holes, 36 in the electrical device 12 to attach the cover plate to the electrical device. When attached the periphery of the cover plate contacts the face 28 of the wall 14 outwardly of the recess 16.

The mask 10 includes a thin plate 38 which is smaller than the cover plate but is large enough to substantially cover the entire electrical device. Typically only the outer extremities of the tabs 20 would not be covered by the plate 38. The plate 38 preferably will cover the entire recess 16 but this is not necessary and it preferably will not extend much beyond the recess. The central portion of the plate 38 is raised to provide a cavity 40 which is configured to receive the user-accessible element. The size and shape of the cavity depend on the type of electrical device the mask will be used with.

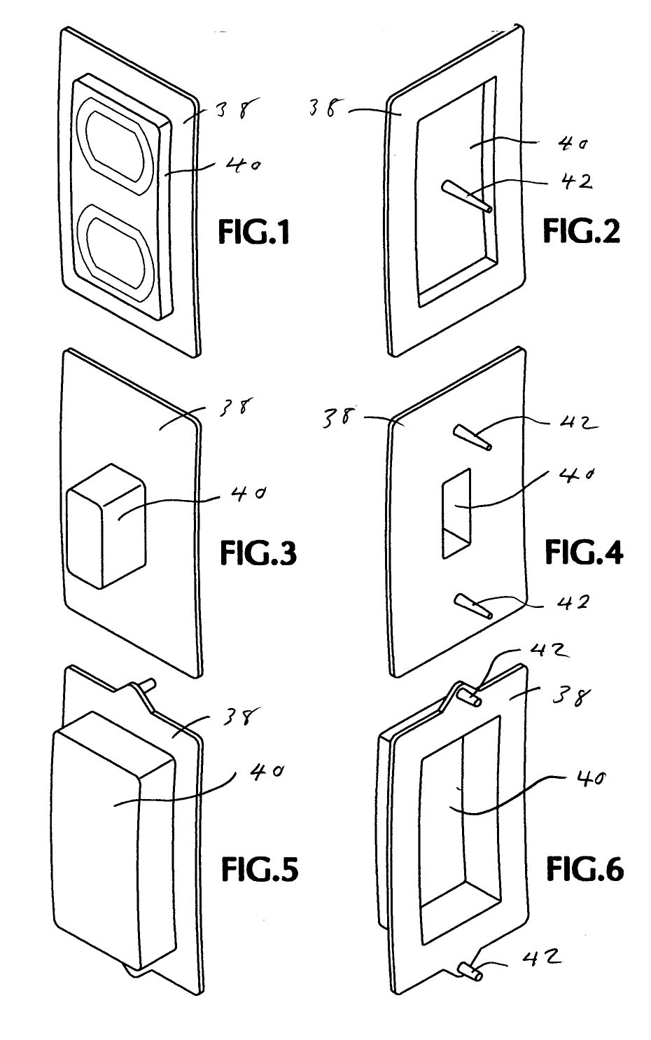

One or more tapered cylindrical studs 42 project inwardly from the plate 38. The number and location of the studs depends on the type of electrical device the mask is intended to cover. If the mask 10 is for a standard double-plug outlet, FIGS. 1 and 2, there is a single stud 42 which is located in the center of the cavity 40. If the mask is for a switch, FIGS. 3 and 4, there are two studs 42 and they are located above and below the cavity. If the mask is for a GIF outlet there are two studs 42 and one is located at the top edge of the plate and the other is located at the bottom edge of the plate. While masks for these three types of wall-mounted electrical devices are shown and described, the invention is not limited in this regard and masks embodying the invention can be made to protect almost any type of wall-mounted electrical device during painting.

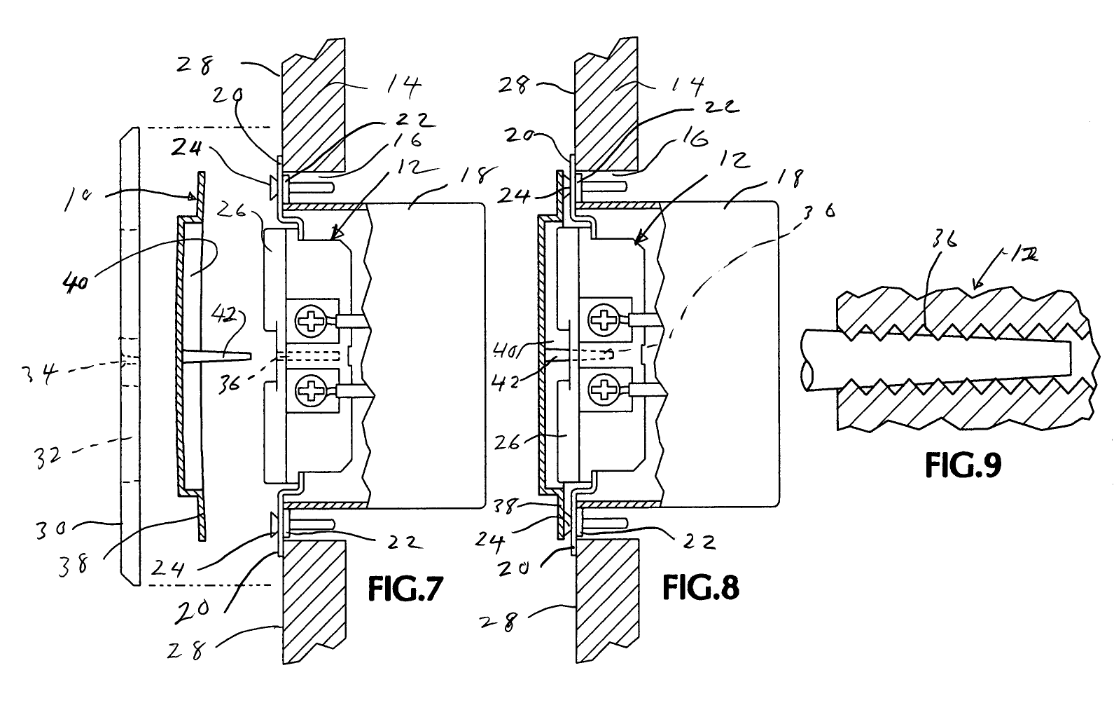

The studs 42 are located such that they extend into the openings 36 when the mask is placed over the electrical device, FIG. 7. The studs are constructed from an elastically deformable material, such as plastic, and are configured so that they become wedged tightly in the holes 36 when the plate is flush with the face 28 of the wall 14, FIG. 8. The threads in the holes 36 deform the studs, FIG. 9, to hold the plate in place. However, due to the deformability of the studs the plate can be removed by pulling it outward, although, this can be done only a limited number of times.

The plate is also made from an elastically deformable material and it preferably is curved along its longitudinal and/or transverse axis. When the plate is installed enough force is applied to it to straighten it out and its resiliency then causes it to seal tightly against the wall when the installation force is removed. As a practical matter the entire perimeter of the plate may not be flush with the wall. For example, if the screws 24 which attach the electrical device to the wall, project from the tabs 20, the plate will not be completely flush with the wall adjacent to the screws. The plate is substantially flush with the wall, however, and when the wall is painted little, if any, paint will flow beneath the plate and no paint will reach the user-accessible element 26.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A mask for temporarily covering an electric device which is mounted in a box located in a recess in a wall and has a user accessible element which protrudes outwardly from the wall and at least one threaded hole which receives a screw that allows a cover plate to be attached to the electrical device, said mask comprising:
(a) a plate having a length and width which causes it to cover substantially all of the electrical device;
(b) said plate having a cavity defined therein which projects outwardly from said plate and is configured to receive said protruding user accessible element of the electrical device;
(c) at least one cylindrical stud which protrudes from said plate, said stud being tapered over substantially its entire extent and being made from an elastically deformable plastic material, said stud being mounted on said plate in a location such that it fits into the hole in the electrical device when said mask is placed over the electrical device; and
(d) the taper and deformability of said stud being such that said stud becomes wedged into the hole in the electrical device at the point where said plate is positioned substantially flush with the wall.

2. The mask of claim 1 wherein said plate substantially covers the recess in the wall.

3. (canceled)

4. The mask of claim and 1 wherein said plate is continuously curved along a longitudinal axis over substantially its entire longitudinal extent when it is not installed on the electrical device.

5. The mask of claim 1 wherein said cavity is configured to fit over a switch toggle and there are two of said studs, said studs being located proximate the longitudinal center of said plate one on each side of said cavity.

6. The mask of claim 1 wherein said cavity is configured to fit over a standard double plug outlet and there is only one stud which is located near the center of said cavity.

7. The mask of claim 1 wherein said cavity is configured to fit over a GIF outlet and there are two of said studs, one being located at a top edge of said plate and one being located at a bottom edge of said plate.

8. The mask of claim 1 wherein the electrical device has outwardly extending tabs through which the electrical device is attached to the box, and said plate covers all of the electrical device except a portion of the tabs.
